(19) United States
(12) Patent Application Publication
(10) Pub. No.: US 2017/0304145 A1
(43) Pub. Date: Oct. 26, 2017

(54) HANDHELD MASSAGE DEVICE

(71) Applicant: TT Therapeutics, LLC, Missouric City, TX (US)

(72) Inventor: Tom Pepe, Missouri City, TX (US)

(73) Assignee: TT Therapeutics, LLC, Missouri City, TX (US)

(21) Appl. No.: 15/493,361

(22) Filed: Apr. 21, 2017

Related U.S. Application Data
(60) Provisional application No. 62/325,566, filed on Apr. 21, 2016.

(51) Int. Cl. A61H 23/02; A61H 23/00

(52) U.S. Cl. CPC A61H 23/02; A61H 23/006; A61H 2201/5023; A61H 2201/0214; A61H 2201/0157; A61H 2201/0153; A61H 2230/50; A61H 2201/0207

(57) ABSTRACT

Disclosed is an electronic handheld device for performing a massage on a user. The device comprises a pair of handles that are substantially parallel to one another, each handle comprising a top and a bottom extremity, a shaft unit housing a shaft comprising a free extremity, the free extremity extending beyond the shaft unit, the shaft being substantially perpendicular to the pair of handles, a motor unit housing a motor, which drives the shaft, a trigger disposed on the primary handle, a trigger disposed in operative communication with the motor wherein, actuating the trigger results in the activation of the motor, and a massage head adapted to be mounted to the free extremity of the shaft whereby, the motion of the shaft is imparted to the massage head at which point, the massage head is applied over the skin of a user.

### CROSS REFERENCE TO RELATED APPLICATION

This application claims priority to U.S. Provisional Patent Application No. 62/325,566, titled “Total Massaging Apparatus” and filed in the United States Patent and Trademark Office on Apr. 21, 2016. The specification of the above referenced patent application is incorporated herein by reference in its entirety.

### BACKGROUND

The present disclosure relates to massaging devices and more particularly to a massaging device, which is designed to provide a variety of therapeutic experiences to a user by employing novel massaging heads, which are subjected to variable motion patterns.

Generally, handheld massaging devices known in the art promise to deliver a “therapeutic experience” to its users. But, in reality, the “therapeutic experience” provided is tantamount to just about a soothing effect. When therapeutic massages provided by masseurs, say, by their hands have proven time and again to be a beneficial beyond delivering a soothing effect, it only proves that the massaging devices in the art have a catching up to do.

What's hindering massaging devices from serving a user beyond providing a mere soothing effect is that, firstly, the massage heads of the massaging devices generally perform one function, which is one of rotation, vibration and percussion. Secondly, the one function performed by the massage device has no variability in speed. Thirdly, the massage heads themselves are of simple rounded shapes, which is a limitation when they can be so much more. And finally, the massage heads employed in the art do not support hot, cold, vibratory and percussive therapeutic techniques. There is a need in the art for a massage device that addresses aforementioned shortcomings of the art.

### SUMMARY

The present invention comprises an electronic, wireless, portable, handheld massage device for relieving muscle aches, stress and pains resulting from strenuous workouts, injuries, etc. The device also aids a user in his/her muscle recovery. The device helps support hot, cold, vibratory and percussive therapeutic techniques by employing means, which will become apparent from the following body of text. The device is adapted to run at variable speeds. The device is adapted for both single and double-handed usage.

The device comprises a monolithic outer body comprising pair of substantially parallel handles viz., primary and secondary. Each handle extends between a top and a bottom extremity. The outer body further comprises a shaft unit overlying the top extremities of the pair of handles. The shaft unit houses a shaft, which comprises a free extremity that extends beyond the shaft unit. Notably, the shaft unit and the pair of handles are integral with respect to one another. The device further comprises a motor unit, which extends perpendicular to the shaft and the pair of handles. The motor unit houses a motor that drives the shaft. The preferable speed of the motor is 2000 cycles per minute and the motor preferably runs on 12-20v power. The motor is disposed in operative mechanical communication with the shaft whereby, the motion outputted by the motor is transmitted to the shaft by means of gears, or the like.

The device comprises a trigger hingedly secured to the primary handle closer to the top extremity thereof wherein, actuating the trigger results in the activation of the motor. In one embodiment, the trigger is lockable, whereby the user can simply press and release the trigger to continuously run the motor. The device further comprises a toggle switch for changing the operational mode of the motor. For example, changing the toggle switch may change direction of the rotation of the motor and thereby, the shaft. In another example, changing the toggle switch may increase/decrease the speed of the motor and thereby, that of the shaft.

The free extremity of the shaft is removably fitted with a massage head whereby, when the motor is activated, the motion of the shaft is imparted to the massage head, at which point, the massage head is said to be active. An active massage head is meant to be applied over the skin of the user in order to deliver a therapeutic effect thereto. The massage heads are categorized into general, cold and hot massage heads. A general massage head is rigid unit at room temperature. A cold massage head is filled with a cold-retaining fluid (or gel) whereby, prior to being applied over the skin, the massage head is refrigerated. Treating the skin with a cold massage head is referred to as a cold therapy. Cold therapy is ideal for treating bruises, swollen body, etc., as cold slows down the blood flow to the injury site thereby reducing inflammation, muscle spasm, pain, swelling, and the like.

The hot massage head is filled with a heat-retaining fluid (or gel) whereby, prior to being applied over the skin, the massage head is warmed in, say, a microwave oven. Treating the skin with a warm massage head is referred to as a hot therapy. Hot therapy opens up blood vessels, which in turn increase blood flow and supplies oxygen and nutrients to reduce pain in joints and relax sore muscles, ligaments, and tendons. The warmth also decreases muscle spasms and can increase range of motion. Applying superficial heat to the body improves the flexibility of tendons and ligaments, reduces muscle spasms, and alleviates pain. The device further comprises an infrared sensor for sensing the temperature of the skin whereon, the massage is to be performed. Based on the temperature sensed, a user may decide which type (hot, cold or rigid) of massage head to use.

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the accompanying drawings, which form a part of this disclosure, wherein:

FIG. 1, according to an embodiment of the present invention, is an illustration of a perspective view of the massage device.

FIG. 2, according to an embodiment of the present invention, is an illustration of another perspective view of the massage device.

FIG. 3, according to an embodiment of the present invention, is an illustration of a side view of the massage device.

FIG. 4, according to an embodiment of the present invention, is an illustration of another side view of the massage device.

FIG. 5, according to an embodiment of the present invention, is an illustration of a front view of the massage device.

FIG. 6, according to an embodiment of the present invention, is an illustration of a rear view of the massage device.

FIG. 7, according to an embodiment of the present invention, is an illustration of a top view of the massage device.

FIG. 8, according to an embodiment of the present invention, is an illustration of a bottom view of the massage device.

FIGS. 9A through 9D, according to an embodiment of the present invention, are illustrations of various massage heads.

The various aspects of the present disclosure mentioned above are described in further detail with reference to the aforementioned figures and the following detailed description of exemplary embodiments.

### FIGURES—REFERENCE NUMERALS

### 10—Massaging Device

### 11—Outer Body

### 12—Primary Handle

### 14—Secondary Handle

### 16—Shaft Unit

### 18—Shaft

### 20—Motor Unit

### 22—Base Member

### 24—Open Space

### 26—Trigger

### 28—Toggle Switch

### 30—Applicator Head

### 31—Infrared Sensor

### 32—Cylindrical Section

### 34—Frusto-conical Section

### 36—Bristle

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

Embodiments of the present invention are directed to an electronic, wireless, portable, handheld massage device for relieving muscle aches, stress and pains resulting from strenuous workouts, injuries, etc. The device also aids a user in his/her muscle recovery. The device helps support hot, cold, vibratory and percussive therapeutic techniques by employing novel means, which will become apparent from the following body of text. The device has various operational modes built thereinto in order to deliver a variety of therapeutic experiences to the user. Furthermore, the device is adapted to run at variable speeds, which results in greater focus being delivered to deepest layers of muscle tissue, tendons, and fascia (i.e., the protective layer surrounding the muscles, joints and bones). As can be appreciated from the illustrations that will be referred to hereinafter, visually, the device looks similar to a drill. The device is adapted for both single and double-handed usage.

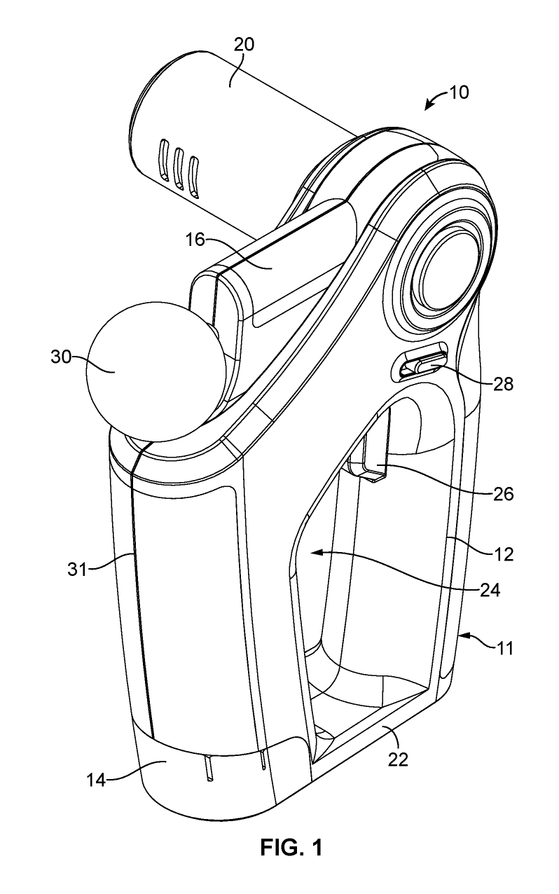

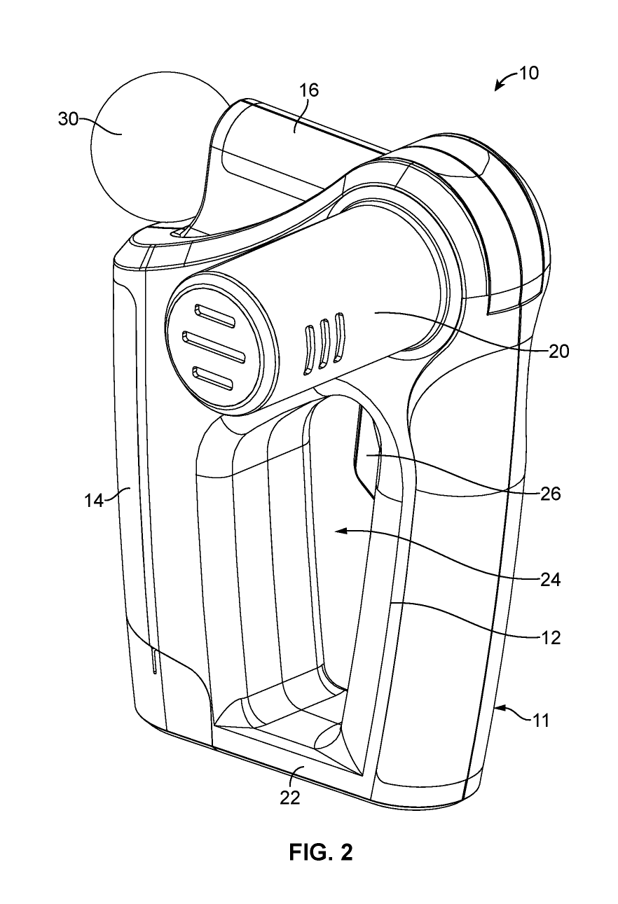

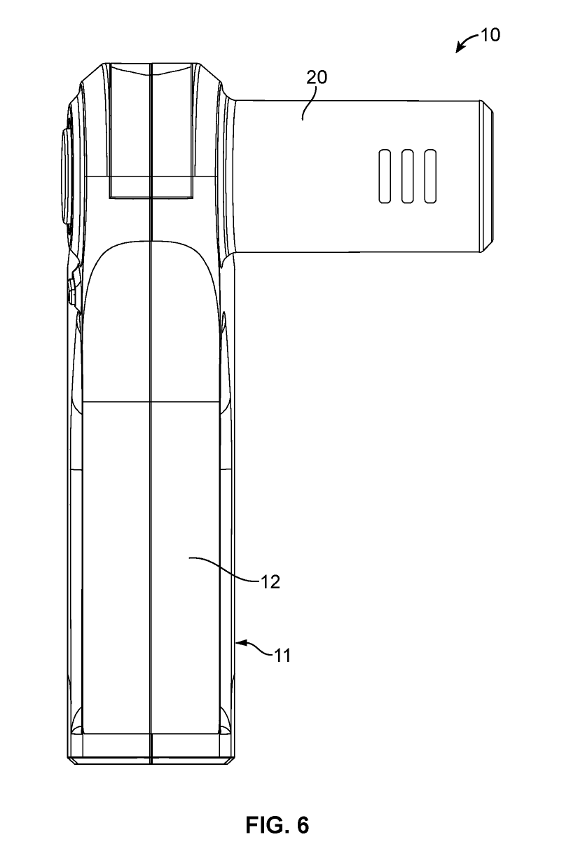

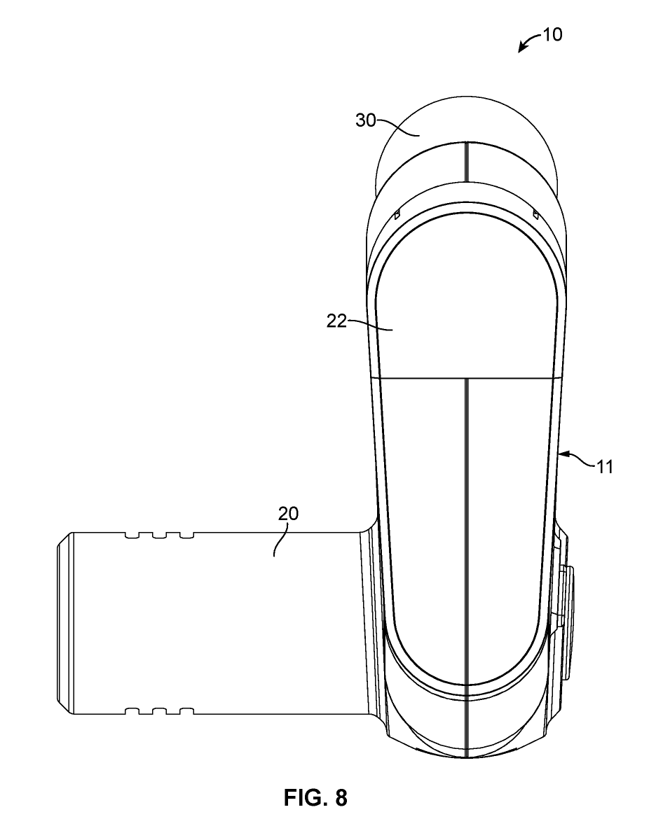

Referring to FIGS. 1 through 6, and 8, the device 10 comprises an outer body 11, which is unitary piece preferably made of a hard plastic material. The outer body 11 comprises pair of substantially parallel handles viz., primary 12 and secondary 14. Each handle, which is preferably substantially cylindrical in shape, extends between a top and a bottom extremity. More particularly, the secondary handle 14 is slightly angularly offset from being parallel to the primary handle 12 such that, the bottom extremity of the secondary handle 14 leans towards that of the primary handle 12. The bottom extremities of both the handles 12 and 14 are joined together by a base member 22, which is substantially perpendicular to both the handles 12 and 14. The base member 22, which is an integral part of the outer body 11, comprises a flat bottom surface about which, the device 10 is placed over a flat surface, such as over a countertop, tabletop, and the like. Each handle comprises a gripping portion (not labeled) disposed thereon for grasping and controlling the device 10. The gripping portion is preferably lined with a soft material for better comfort in handling the device 10. In one embodiment, the gripping portion comprises finger indentations thereon for better ergonomics. The primary and secondary handles 12 and 14 are meant to be gripped by dominant and non-dominant hands respectively. For example, if the user is right-handed, then the primary handle 12 is meant to be gripped by his/her right hand, while the secondary handle 14 is meant to be gripped by his/her left hand. The primary handle 12 comprises a trigger hole (not shown) disposed closer to the top extremity thereof and opposingly-disposed to the secondary handle 14. The utility of the trigger hole will become apparent from the following body of text.

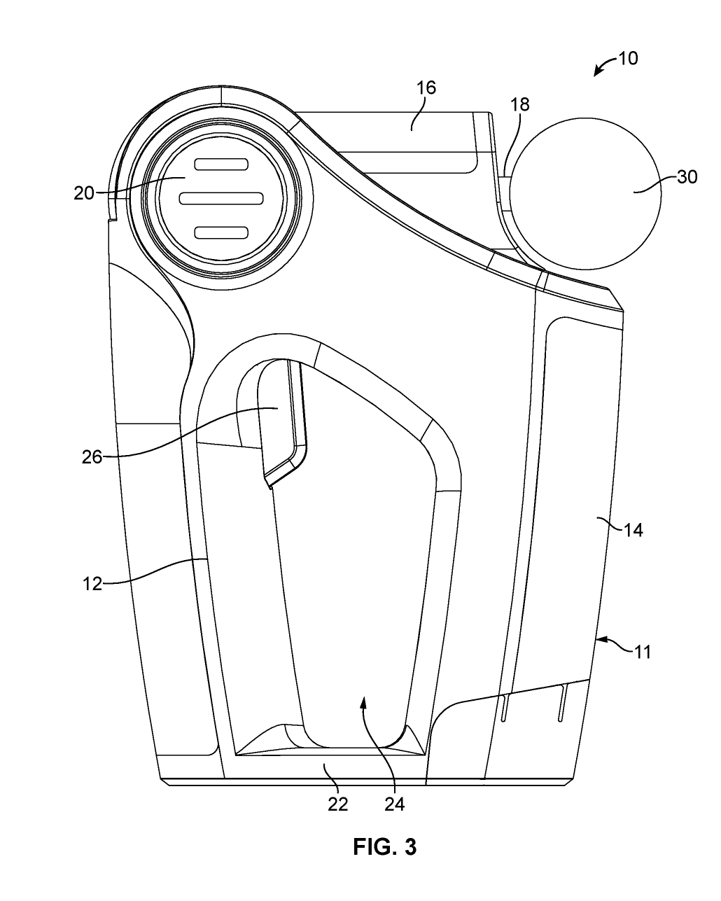

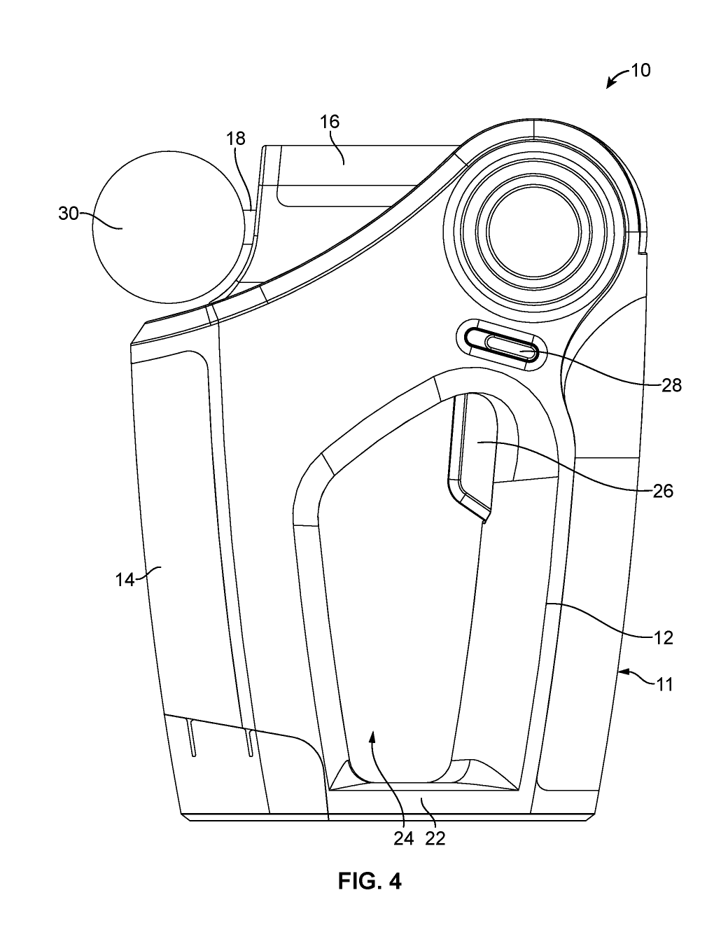

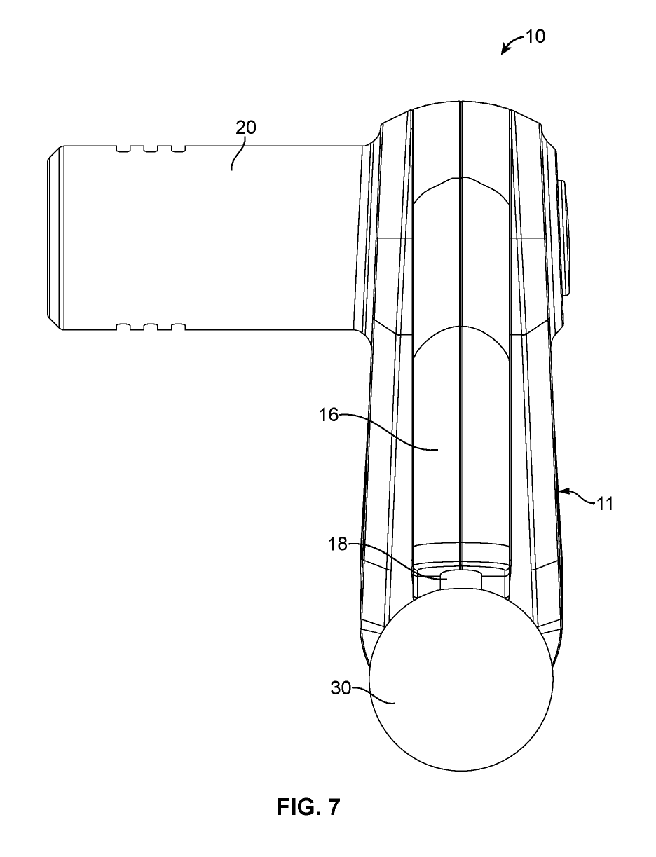

Referring to FIGS. 1 through 4, 7 and 8, the outer body 11 further comprises a shaft unit 16 overlying the top extremities of the pair of handles 12 and 14. The length of the shaft unit 16 spans the entire top extremity of the primary handle 12 and extends therefrom (towards the top extremity of the secondary handle 14) till a portion of the top extremity of the secondary handle 14. More particularly, as can be appreciated from FIGS. 3 and 4, the length of the shaft unit 16 terminates at substantially midway of the top extremity of the secondary handle 14. The shaft unit 16 houses a shaft 18, which comprises a free extremity that extends beyond the extremity of the shaft unit 16—i.e., the extremity of the shaft unit 16 overlying the secondary handle 14. Notably, the shaft unit 16, the base member 22, and the pair of handles 12 and 14 are integral with respect to one another and define an open space 24 therebetween. The open space 24 enables a user to wrap his/her fingers around the primary handle 12 in order to grip the same.

Referring to FIGS. 1 through 8, the device 10 further comprises a motor unit 20, which comprises a cylindrical structure extending through the integral portion of the device 10 that joins the primary handle 12 and the shaft unit 16. While one extremity of the motor unit 20 is substantially flush with the surface of the integral portion, the other extremity extends perpendicular to the shaft 18 and the pair of handles 12 and 14. In one embodiment, the motor unit 20 may be used as an auxiliary handle. The motor unit 20 houses a motor (not shown) that drives the shaft 18. The preferable speed of the motor is 2000 cycles per minute and the motor preferably runs on 12-20v power. The motor unit 20 comprises a plurality of vents disposed thereon for dissipating therethrough the heat generated by the running motor. The motor is disposed in operative mechanical communication with the shaft 18 whereby, the motion outputted by the motor is transmitted to the shaft 18 by means of gears, or the like. More particularly, the motion transmitted to the shaft 18 is rotary motion. In one embodiment, the motion imparted to the shaft 18 by the motor is pulsating, longitudinal to-and-fro motion. Notably, the to-and-fro motion is part of percussive massage therapy. In another embodiment, vibration is imparted to the motor to the shaft 18 wherein, the vibration is employed for vibratory therapy. The motor is powered by a rechargeable battery, which is preferably housed within one of the handles.

Referring to FIGS. 1 through 4, the device 10 comprises a trigger 26 secured to the primary handle 12 closer to the top extremity thereof wherein, the trigger 26 is hingedly seated within the trigger hole. The trigger 26 is disposed in electrical operative communication with the motor such that, actuating the trigger 26 results in the activation of the motor. In one embodiment, the trigger 26 is lockable, whereby, in the event of the motor being inactive, the user, simply pressing and releasing (as opposed to pressing and holding) the trigger 26 to activates and runs the motor. As can be appreciated from FIGS. 1 and 4, the device 10 further comprises a toggle switch 28 for changing the operational mode of the motor. For example, changing the toggle switch 28 may change direction of the rotation of the motor and thereby, the shaft 18. In another example, changing the toggle switch 28 may increase/decrease the speed of the motor and thereby, that of the shaft 18.

Referring to FIGS. 1 through 5, 7 and 8, the free extremity of the shaft 18 is removably fitted with a massage head 30 whereby, when the motor is activated, the motion of the shaft 18 is imparted to the massage head 30, at which point, the massage head 30 is said to be active. An active massage head 30 is meant to be applied over the skin of the user in order to deliver a therapeutic effect thereto. The massage head 30 comprises a central hole (not shown) within which, the free extremity of the shaft 18 is received so as to mount the massage head 30 to the shaft 18.

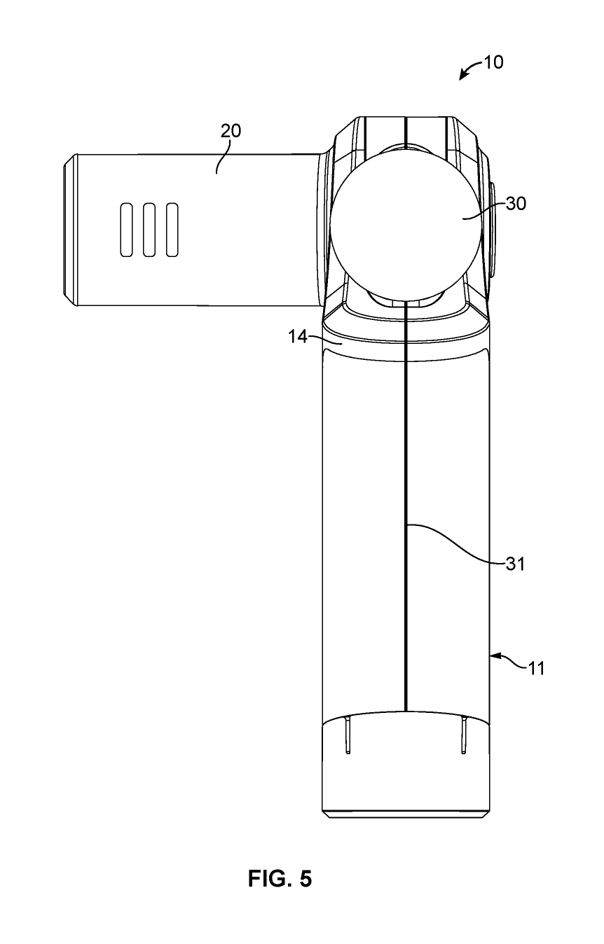

Still referring to FIGS. 1 through 5, 7 and 8, the massage heads 30 are categorized into general, cold and hot massage heads 30. A general massage head 30 is rigid unit at room temperature. A cold massage head 30 is filled with a cold-retaining fluid (or gel) whereby, prior to being applied over the skin, the massage head 30 is refrigerated. Treating the skin with a cold massage head 30 is referred to as a cold therapy. Cold therapy is ideal for treating bruises, swollen body, etc., as cold slows down the blood flow to the injury site thereby reducing inflammation, muscle spasm, pain, swelling, and the like. The hot massage head 30 is filled with a heat-retaining fluid (or gel) whereby, prior to being applied over the skin, the massage head 30 is warmed in, say, a microwave oven. Treating the skin with a warm massage head 30 is referred to as a hot therapy. Hot therapy opens up blood vessels, which in turn increase blood flow and supplies oxygen and nutrients to reduce pain in joints and relax sore muscles, ligaments, and tendons. The warmth also decreases muscle spasms and can increase range of motion. Applying superficial heat to the body improves the flexibility of tendons and ligaments, reduces muscle spasms, and alleviates pain. The massage heads 30 employed for hot and cold therapies comprise flexible exteriors encompassing the gel. The device 10 further comprises an infrared sensor 31 for sensing the temperature of the skin whereon, the massage is to be performed. The device further comprises an infrared sensor 31 for sensing the temperature of the skin whereon, the massage is to be performed. As can be appreciated from FIGS. 1 and 5, the infrared sensor 31 is disposed on the outer side of the secondary handle 14 directly below the massage head 30. Based on the temperature sensed, a user may decide which type of massage head 30 to use.

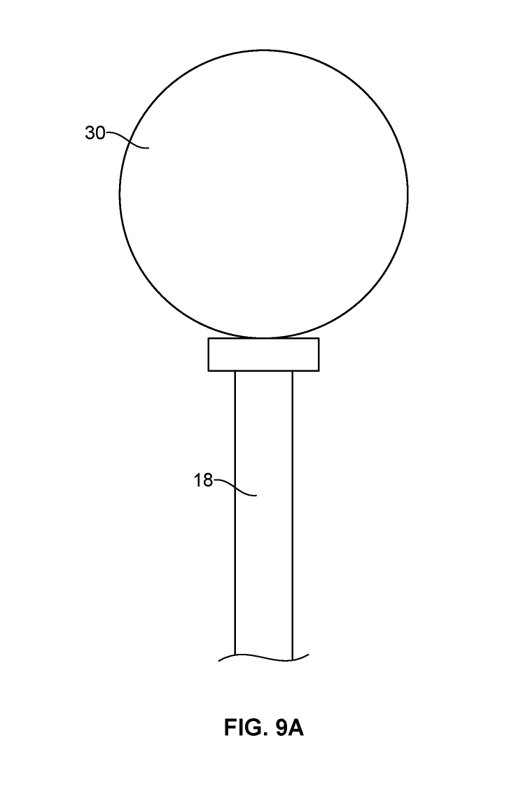

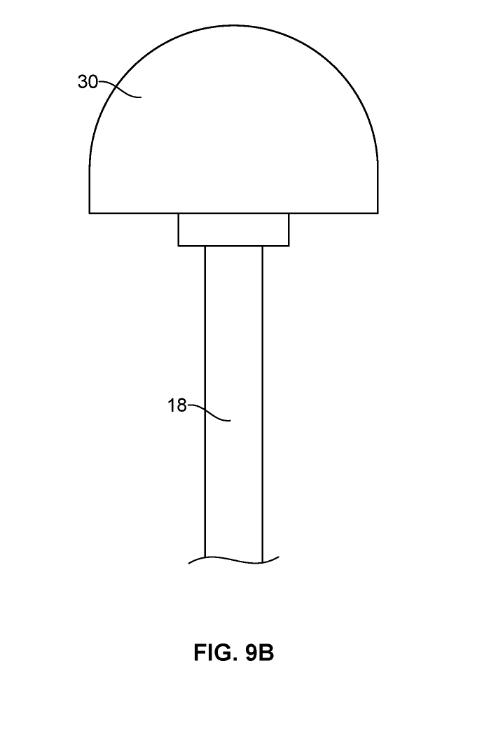

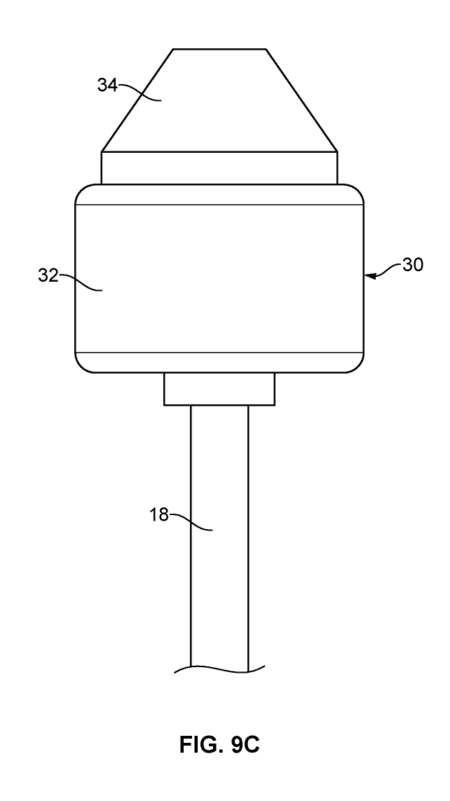

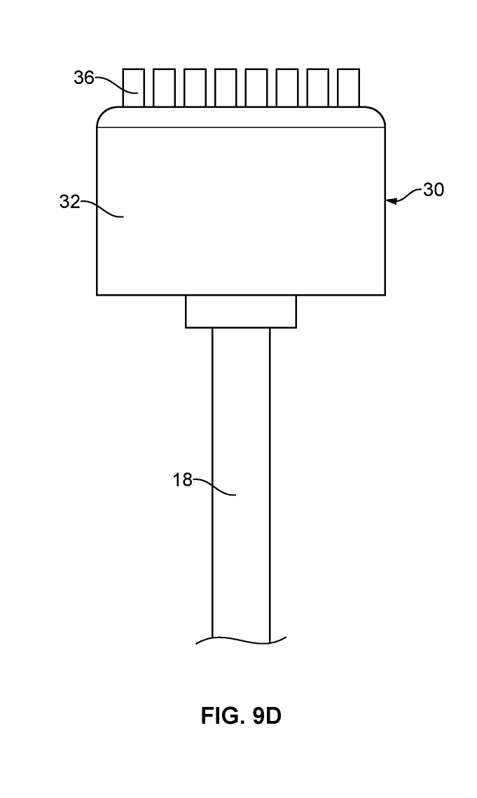

Referring to FIGS. 9A through 9D, massage heads 30 of various shapes are envisioned to be used in conjunction with the shaft 18. As evident, FIGS. 9A and 9B teach massage heads 30 of simple spherical and hemispherical shapes respectively. As can be appreciated from FIG. 9C, the massage head 30 is divided into a cylindrical section 32 and a frusto-conical section 34. The circular base of the frusto-conical section 34 is attached circular surface of the cylindrical section 32 in order to form of the massage head 30 of this embodiment. The other circular surface of the cylindrical section 32 comprises the aforementioned central hole for receiving the free extremity of the shaft 18 therewithin. In yet another embodiment, as can be appreciated from FIG. 9D, the massage head 30 is divided into a cylindrical section 32 and a multiplicity stubby bristles 36, which are relatively rigid (compared to general bristles on a bursh or the like). The bristles 36 integrally extend from the circular surface of the cylindrical section 32 in order to form of the massage head 30 of this embodiment. The other circular surface of the cylindrical section 32 comprises the aforementioned central hole for receiving the free extremity of the shaft 18 therewithin.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An electronic handheld massage device comprising:
(a) an outer body comprising:
(i) a pair of substantially parallel handles, viz., primary and secondary, each handle extending between a top and a bottom extremity; and
(ii) a shaft unit housing a shaft comprising a free extremity, the free extremity extending beyond the shaft unit, the shaft unit abutting the top extremities of the pair of handles, the shaft being substantially perpendicular to the pair of handles;
(b) a motor unit housing a motor, which drives the shaft;
(c) a trigger disposed in operative communication with the motor wherein, actuating the trigger results in the activation of the motor; and
(d) a massage head adapted to be mounted to the free extremity of the shaft whereby, the motion of the shaft is imparted thereto at which point, the massage head is said to be active; an active massage head to be applied over the skin of a user.

2. The device of claim 1 wherein, the motor is powered by a rechargeable battery.

3. The device of claim 1 wherein, the trigger is disposed on the primary handle.

4. The device of claim 1 wherein, the outer body further comprises a base member integrally connecting the bottom extremities of the pair of handles, the base member comprising a flat bottom surface about which, the device is placed over a flat surface, the base member being substantially perpendicular to the pair of handles; an open space defined between the pair of handles, the base member and the shaft unit.

5. The device of claim 1 wherein, the motor unit extends through the outer body such that, one side of the motor unit is flush with the outer body.

6. The device of claim 1 wherein, the trigger is lockable whereby, when the motor is inactive, pressing and releasing the trigger activates and runs the motor.

7. The device of claim 1 further comprising a toggle switch, which is disposed in operative communication with the motor, the toggle switch for changing the motor from one operational mode to another, which accordingly results in the change of the motion pattern of the shaft, which in turn results in the change of the motion pattern of the massage head.

8. The device of claim 1 further comprising a toggle switch, which is disposed in operative communication with the motor, the toggle switch for changing the motor speed, which accordingly results in a change in the speed of the shaft and thereby, that of the massage head.

9. The device of claim 1 wherein, the shape of the massage head comprises one of:
spherical, hemispherical and cylindrical.

10. The device of claim 1 wherein, the massage head comprises a cylindrical section comprising top and bottom flat surfaces and a frusto-conical section comprising a flat bottom base, the base of the frusto-conical section attached to the top surface of the cylindrical section; the bottom surface of the cylindrical section adapted to receive the free extremity of the shaft.

11. The device of claim 1 wherein, the massage head comprises a cylindrical section comprising top and bottom flat surfaces and a multiplicity of stubby, rigid bristles integrally extending from the top surface thereof; the bottom surface of the cylindrical section adapted to receive the free extremity of the shaft.

12. The device of claim 1 wherein, the massage head, which comprises a cold-retaining fluid therewithin, is adapted to be refrigerated prior to being applied over the skin of a user.

13. The device of claim 1 wherein, the massage head, which comprises a heat-retaining fluid therewithin, is adapted to be warmed prior to being applied over the skin of a user.

14. The device of claim 1 wherein, the interior of the massage head comprises a flexible gel-like material.

15. The device of claim 1 wherein, as a result of the actuation of the trigger, the motion imparted to the shaft by the motor is rotation.

16. The device of claim 1 wherein, as a result of the actuation of the trigger, the motion imparted to the shaft by the motor is vibration.

17. The device of claim 1 wherein, as a result of the actuation of the trigger, the motion imparted to the shaft by the motor is pulsating, longitudinal to-and-fro motion, the to-and-fro motion being part of a percussive therapy.

18. The device of claim 1 wherein, the motor is adapted to rotate at 2000 cycles per minute.

19. The device of claim 1 further comprising an infrared sensor for detecting skin temperature, the infrared sensor disposed at a location on the secondary handle, which is directly below the massage head.

20. The device of claim 1 wherein, the motor is adapted to run at variable speeds.
